(19) United States
(12) Patent Application Publication
(10) Pub. No.: US 2012/0004740 A1
(43) Pub. Date: Jan. 5, 2012

(54) INPUT DEVICE AND INPUT METHOD

(75) Inventor: YAN-MEI YANG, HSINCHU CITY (TW)

(73) Assignee: YOMORE TECHNOLOGY CO., LTD., KAOHSIUNG CITY (TW)

(21) Appl. No.: 13/158,635

(22) Filed: Jun. 13, 2011

(30) Foreign Application Priority Data
Jul. 5, 2010 (TW) 099121987

(51) Int. Cl. G05B 11/01

(52) U.S. Cl. 700/12

(57) ABSTRACT

An input device is operable in a plurality of control modes for providing signals to at least one controlled device. The input device includes: a sensor unit that detects variation in acceleration of the input device resulting from moving the input device, and that outputs a sensor signal corresponding to the variation in acceleration. A user operable input unit is operable by a user to output an input signal. A control unit switches operation of the input device from one of the control modes to another one of the control modes upon determining that the variation in the acceleration has reached a predetermined threshold. The control unit generates an output signal that corresponds to the input signal and that is in accordance with a current one of the control modes in which the input device operates. A transmission unit transmits the output signal to the controlled device.

### CROSS-REFERENCE TO RELATED APPLICATION

This application claims priority of Taiwanese Application No. 099121987, filed on Jul. 5, 2010.

### BACKGROUND OF THE INVENTION

1. Field of the Invention

The present invention relates to an input device and an input method, more particularly to an input device and an input method capable of control mode switching.

2. Description of the Related Art

Conventional input devices such as a remote controller, a wireless keyboard, and a wireless mouse have been widely applied in a variety of appliances such as a television, a video recorder, a stereo system, an air conditioner, a vehicle, an automatic rolling door, a lamp, a projector, a computer, etc.

Even though a remote controller has advantages of easy operation and relatively low cost, operation of the remote controller may only be performed by using buttons thereof such that applicability of the remote controller is limited. Another conventional remote controller has an extended input function, such as selecting TV programs in a television program guide through the remote controller. However, users find it hard to memorize complicated button operation, and they are only allowed to select from fixed menus and are not able to input characters or symbols arbitrarily. Therefore, the conventional remote controller has relatively low flexibility and inferior expandability in operation, and thus may not satisfy requirement of future home entertainment audio-video products.

Moreover, a conventional input device such as a touchpad is generally applied in a notebook computer or a smart phone to replace a mouse device for inputting. A touchpad has advantages such as water-resistant, impact-resistant, and intuitional operation. However, application of touchpads is usually limited to computers and mobile phones.

In view of diversity of current electronic products and influence thereof on everyone's daily life, a demand for input devices capable of human-machine interaction increases day by day. However, as the electronic products increase in number, the number of input devices also increases. Therefore, the input devices are usually confused with each other and each input device has buttons that have similar functions, such that resources are squandered and time for matching an input device with a corresponding electronic product is wasted.

### SUMMARY OF THE INVENTION

Therefore, an object of the present invention is to provide an input device and an input method capable of expanding control functionality.

Accordingly, the input device of the present invention is operable in a plurality of control modes for providing signals to at least one controlled device. The input device includes a sensor unit, a user operable input unit, a control unit, and a transmission unit.

The sensor unit is for detecting variation in acceleration of the input device resulting from moving the input device, and outputting a sensor signal corresponding to the variation in acceleration detected thereby. The user operable input unit is operable by a user to output an input signal. The control unit is coupled to the sensor unit and the user operable input unit. The control unit is configured to switch operation of the input device from one of the control modes to another one of the control modes upon determining from the sensor signal that the variation in the acceleration detected by the sensor unit has reached a predetermined threshold. The control unit is further configured to generate an output signal that corresponds to the input signal and that is in accordance with a current one of the control modes in which the input device operates. The transmission unit is coupled to the control unit, receives the output signal from the control unit, and transmits the output signal to the controlled device.

In an aspect of the invention, the input device is operable in a plurality of control modes for providing signals to at least one controlled device. The input device includes a sensor unit, a plurality of user operable input units, a control unit, and a transmission unit.

The sensor unit is for detecting variation in acceleration of the input device resulting from moving the input device, and outputting a sensor signal corresponding to the variation in acceleration detected thereby. Each of the user operable input units corresponds to one of the control modes and is operable by a user to output an input signal. The control unit is coupled to the sensor unit and the user operable input units. The control unit is configured to switch operation of the input device from one of the control modes to another one of the control modes upon determining from the sensor signal that the variation in the acceleration detected by the sensor unit has reached a predetermined threshold. The control unit is further configured to generate an output signal that is in accordance with a current one of the control modes in which the input device operates and that corresponds to the input signal from the user operable input unit corresponding to the current one of the control modes. The transmission unit is coupled to the control unit, receives the output signal from the control unit, and transmits the output signal to the controlled device.

In yet another aspect of the invention, the input device is operable in a plurality of control modes for providing signals to at least one controlled device. The input device includes a sensor unit, a plurality of user operable input units, an input selecting unit, a control unit, and a transmission unit.

The sensor unit is for detecting variation in acceleration of the input device resulting from moving the input device, and outputting a sensor signal corresponding to the variation in acceleration detected thereby. Each of the user operable input units corresponds to one of the control modes and is operable by a user to output an input signal. The input selecting unit is coupled to the sensor unit and the user operable input units. The input selecting unit is configured to switch operation of the input device from one of the control modes to another one of the control modes upon determining from the sensor signal that the variation in the acceleration detected by the sensor unit has reached a predetermined threshold, and to select the input signal from the user operable input unit corresponding to a current one of the control modes, in which the input device operates, for generating an intermediate signal to be outputted thereby. The control unit is coupled to the input selecting unit and is configured to generate an output signal that is in accordance with the current one of the control modes and that corresponds to the intermediate signal from the input selecting unit. The transmission unit is coupled to the control unit, receives the output signal from the control unit, and transmits the output signal to the controlled device.

Further, the input method of the present invention is to be performed by an input device for providing signals to at least one controlled device. The input device is operable in a plurality of control modes. The control method includes:

a) detecting, through a sensor unit of the input device, variation in acceleration of the input device resulting from moving the input device, and outputting a sensor signal corresponding to the detected variation in acceleration;

b) configuring a control unit of the input device to switch operation of the input device to a selected one of the control modes with reference to the sensor signal; and

c) selecting one of a plurality of input signals according to the selected one of the control modes and transmitting the selected one of the input signals to the controlled device.

An effect of the input device and the input method of the present invention is achieved by switching operation of the input device from one of the control modes to another one of the control modes upon determining that the variation in the acceleration has reached a predetermined threshold, so as to switch control functions of the input device.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram illustrating a first preferred embodiment of an input device of the present invention wherein the input device includes a user operable input unit;

FIG. 2 is a perspective view illustrating an operation surface of the user operable input unit of the input device in the first preferred embodiment;

FIG. 3 is a block diagram illustrating a second preferred embodiment of an input device of the present invention wherein the input device includes two user operable input units;

FIG. 4 is a perspective view illustrating a first operation surface for controlling a television in the second preferred embodiment of the present invention;

FIG. 5 is a perspective view illustrating a second operation surface for controlling a computer in the second preferred embodiment of the present invention;

FIG. 6 is a schematic diagram illustrating a principle for detecting variation in acceleration of the input device;

FIG. 7 is a perspective view illustrating the input device with a cubic appearance;

FIG. 8 is a perspective view illustrating the input device with a cylindrical appearance;

FIG. 9 is a perspective view illustrating the input device with a pyramidal appearance;

FIG. 10 is a perspective view illustrating the input device which has the appearance of a foldable plate unit having a plurality of plate bodies; and

FIG. 11 is a block diagram illustrating a third preferred embodiment of an input device of the present invention wherein the input device includes an input selecting unit.

### DETAILED DESCRIPTION OF THE PREFERRED EMBODIMENTS

Before the present invention is described in greater detail with reference to the preferred embodiments, it should be noted that the same reference numerals are used to denote the same elements throughout the following description.

Moreover, in the following content, an input device of the present invention may be integrated into any form of portable electronic devices during application, and should not be limited to a remote controller. Further, a user operable input unit may be operable for controlling different functions of at least one controlled device, and may be operable for transmitting control commands or data to the controlled devices.

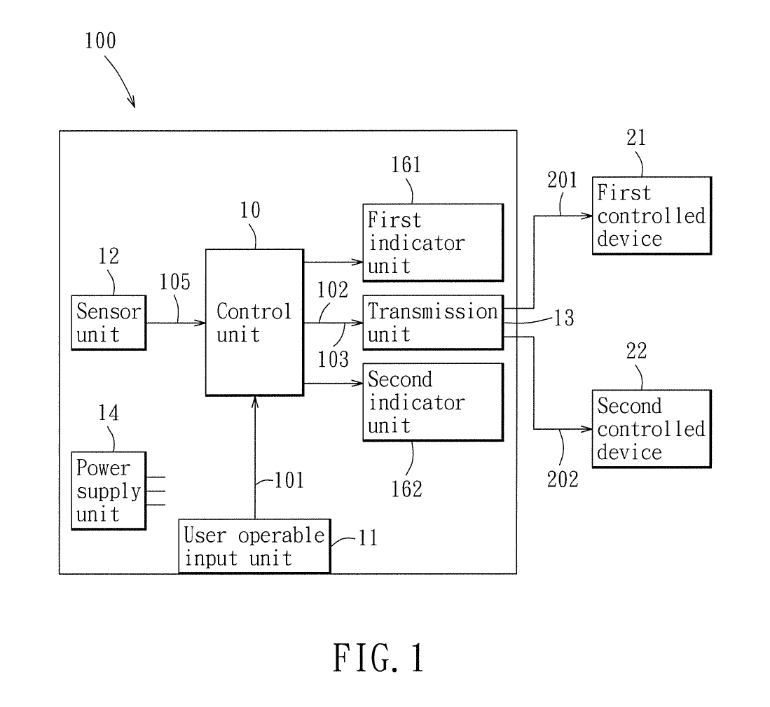

Referring to FIG. 1, a first preferred embodiment of an input device 100 of the present invention is operable in a plurality of control modes for providing signals to a first controlled device 21 and a second controlled device 22. In this embodiment, the first controlled device 21 is a multimedia displayer such as a television (TV), and the second controlled device 22 is an air conditioner (AC).

The input device 100 includes a sensor unit 12, a user operable input unit 11, a control unit 10, and a transmission unit 13. The sensor unit 12 is for detecting variation in acceleration of the input device 100 resulting from moving the input device 100, and outputting a sensor signal 105 corresponding to the variation in acceleration detected thereby. The user operable input unit 11 is operable by a user to output an input signal 101. The control unit 10 is coupled to the sensor unit 12 and the user operable input unit 11. The input device 100 is preset to operate in a first control mode that corresponds to the first controlled device 21. The control unit 10 is configured to generate a first output signal 102 that corresponds to the input signal 101 and that is in accordance with a current one of the control modes in which the input device 100 operates, i.e., the first control mode. The transmission unit 13 is coupled to the control unit 10, receives the first output signal 102 from the control unit 10, processes the first output signal 102 into a formatted first transmission signal 201, and transmits the first transmission signal 201 to the controlled device that corresponds to the first control mode, i.e., the first controlled device 21. The control unit 10 is further configured to switch operation of the input device 100 from the first control mode to a second control mode upon determining from the sensor signal 105 that the variation in the acceleration detected by the sensor unit 12 has reached a predetermined threshold, then the control unit 10 is further configured to generate a second output signal 103 that corresponds to the input signal 101 and that is in accordance with the second control mode in which the input device 100 currently operates. The transmission unit 13 receives the second output signal 103 from the control unit 10, processes the second output signal 103 into a formatted second transmission signal 202, and transmits the second transmission signal 202 to the controlled device that corresponds to the second control mode, i.e., the second controlled device 22.

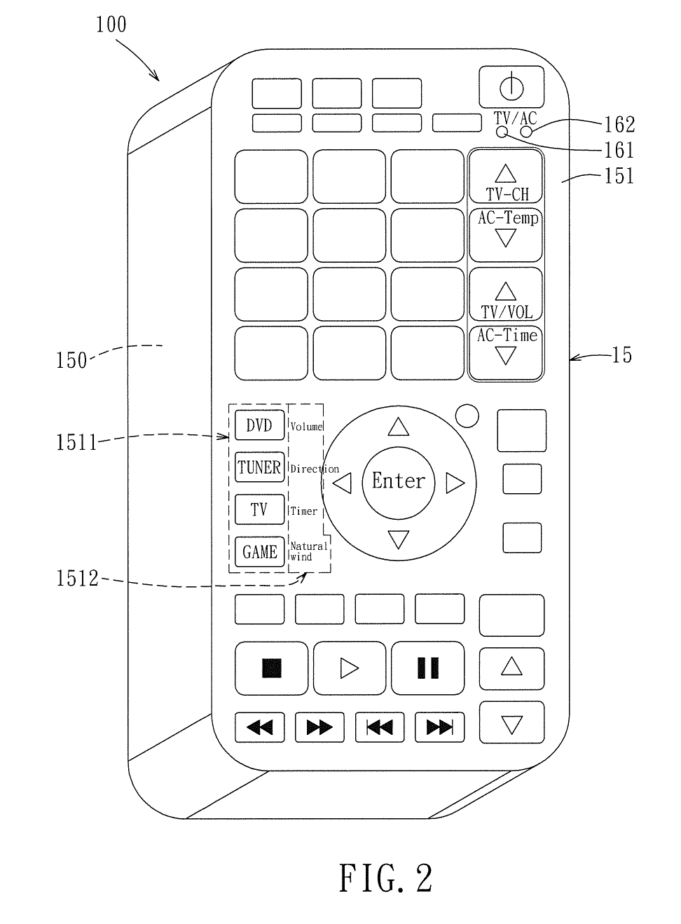

Referring to FIG. 2, the input device 100 further includes a main body 15 defining a receiving space 150 for receiving the aforesaid components, and a first indicator unit 161 and a second indicator unit 162. The body 15 has an operation surface 151. Each of the first indicator unit 161 and the second indicator unit 162 is disposed on the operation surface 151, is coupled to the control unit 10, corresponds to a respective one of the first and second control modes, and is activated by the control unit 10 when the input device 100 operates in the corresponding one of the first and second control modes. In this embodiment, each of the first and second indicator units 161, 162 is a light emitting diode (LED) indicator lamp. The operation surface 151 is labeled with a first indication area 1511 and a second indication area 1512.

Referring to FIGS. 1 and 2, in this preferred embodiment, the input device 100 is preset to operate in the first control mode when the input device 100 is turned on. When the first indicator unit 161 is activated, it means that the input device 100 operates in the first control mode (for example, a multimedia control mode). In the first control mode, when control buttons (such as buttons labeled as DVD, TUNER or TV) indicated by the first indication area 1511 are operated, the input device 100 may control functions of the first controlled device 21 in the DVD mode, TUNER mode, or TV mode.

When the second indicator unit 162 is activated, it means that the input device 100 operates in the second control mode (for example, an AC control mode). In the second control mode, when the control buttons (such as buttons labeled as Volume, Direction and Timer) indicated by the second indication area 1512 are operated, the input device 100 may control wind volume, wind direction, or timer of the second controlled device 22.

Principle of operation of the input device 100 is explained in more detail hereinafter:

The input device 100 further includes a power supply unit 14 for supplying power to the aforementioned sensor unit 12, the user operable input unit 11, the control unit 10, the transmission unit 13, and the first and second indicator unit 161, 162. In this embodiment, the user operable input unit 11 is a control button set that is disposed on the operation surface 151 and that is operable by the user to output a button signal, i.e., the input signal 101. However, in other configurations, the user operable input unit 11 is a touchpad operable by the user to output a touch signal, i.e., the input signal 101, and a surface of the touchpad is designed as the control button set on the operation surface 151 as illustrated in FIG. 2. When the operation surface 151 is operated by the user, the input signal 101 containing information about coordinate position where the touchpad is touched is outputted from the user operable input unit 11. Moreover, the user operable input unit 11 may also be achieved by a combination of a touchpad and a physical button set, and should not be limited to the disclosure in this preferred embodiment.

The sensor unit 12 is an accelerometer disposed in the receiving space 150 for detecting variation in acceleration of the input device 100 resulting from moving the input device 100, and outputting the sensor signal 105 corresponding to the variation in acceleration detected thereby. If the user wants to switch control mode of the input device 100, the user may shake the main body 15 of the input device 100. Accordingly, the control unit 10 is configured to switch operation of the input device 100 from one of the control modes to another one of the control modes upon determining from the sensor signal 105 that the variation in the acceleration detected by the sensor unit 12 has reached the predetermined threshold, and to switch activation of the LED lamps of the first indicator unit 161 and the second indicator unit 162 such that the user may be aware of which control mode the input device 100 operates.

Preferably, the transmission unit 13 may be a wireless transmission unit. The wireless transmission unit is selected from a Bluetooth transmitter, a wireless broadband transmitter, a Zigbee transmitter, and a radio-frequency transmitter. In other configurations, the transmission unit is a wired transmission unit. The wired transmission unit is selected from a USB port, an IEEE1394 transmission port, and a UART transmission port.

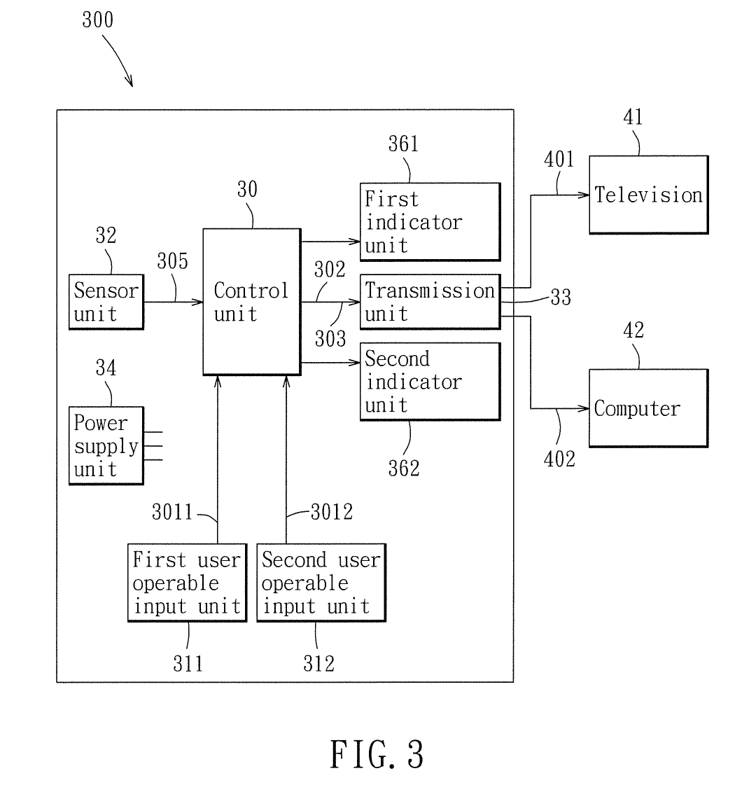

Referring to FIG. 3, a second preferred embodiment of an input device 300 of the present invention is illustrated. The input device 300 is operable in a first control mode and a second control mode for providing signals to a television 41 and a computer 42, respectively. The input device 300 includes a sensor unit 32, a plurality of user operable input units (i.e., a first user operable input unit 311 and a second user operable input unit 312), a control unit 30, a transmission unit 33, a first indicator unit 361, a second indicator unit 362, and a power supply unit 34 for supplying power to the aforesaid components.

The sensor unit 32 is for detecting variation in acceleration of the input device 300 resulting from moving the input device 300, and outputting a sensor signal 305 corresponding to the variation in acceleration detected thereby. Each of the first and second user operable input units 311, 312 corresponds to a respective one of the first control mode and the second control mode, and is operable by a user to output a respective one of a first input signal 3011 and a second input signal 3012. The control unit 30 is coupled to the sensor unit 32 and the first and second user operable input units 311, 312. The input device 300 is preset to operate in the first control mode that corresponds to the television 41. The control unit 30 is configured to generate a first output signal 302 that is in accordance with the first control mode and that corresponds to the first input signal 3011 from the first user operable input unit 311 corresponding to the first control mode. The transmission unit 33 is coupled to the control unit 30, receives the first output signal 302 from the control unit 30, processes the first output signal 302 into a formatted first transmission signal 401, and transmits the first transmission signal 401 to the television 41 that corresponds to the first control mode. The control unit 30 is further configured to switch operation of the input device 300 from the first control mode to the second control mode upon determining from the sensor signal 305 that the variation in the acceleration detected by the sensor unit 32 has reached a predetermined threshold. The control unit 30 is further configured to generate a second output signal 303 that is in accordance with the second control mode and that corresponds to the second input signal 3012 from the second user operable input unit 312 corresponding to the second control mode. The transmission unit 33 receives the second output signal 303 from the control unit 30, processes the second output signal 303 into a formatted second transmission signal 402, and transmits the second transmission signal 402 to the computer 42 that corresponds to the second control mode.

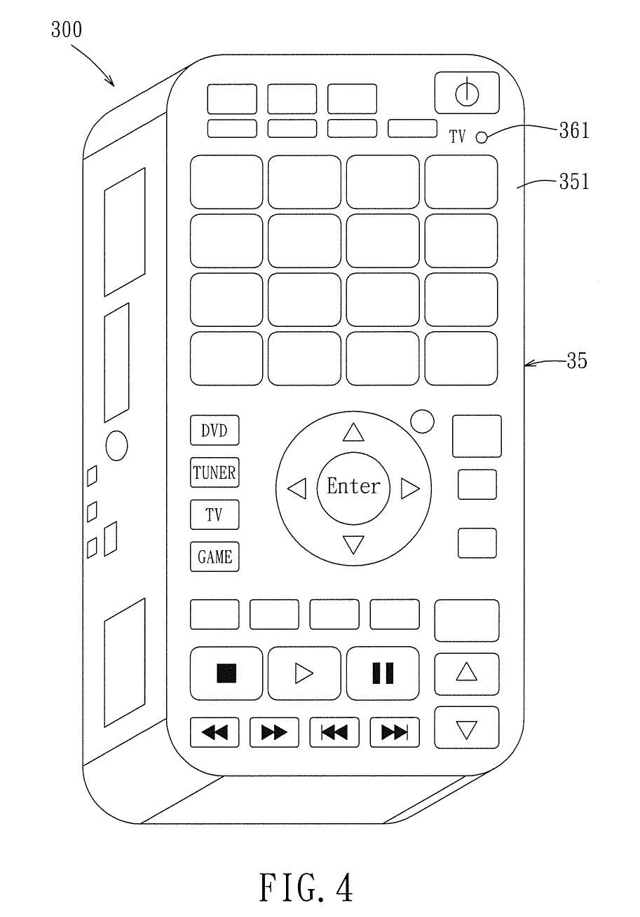

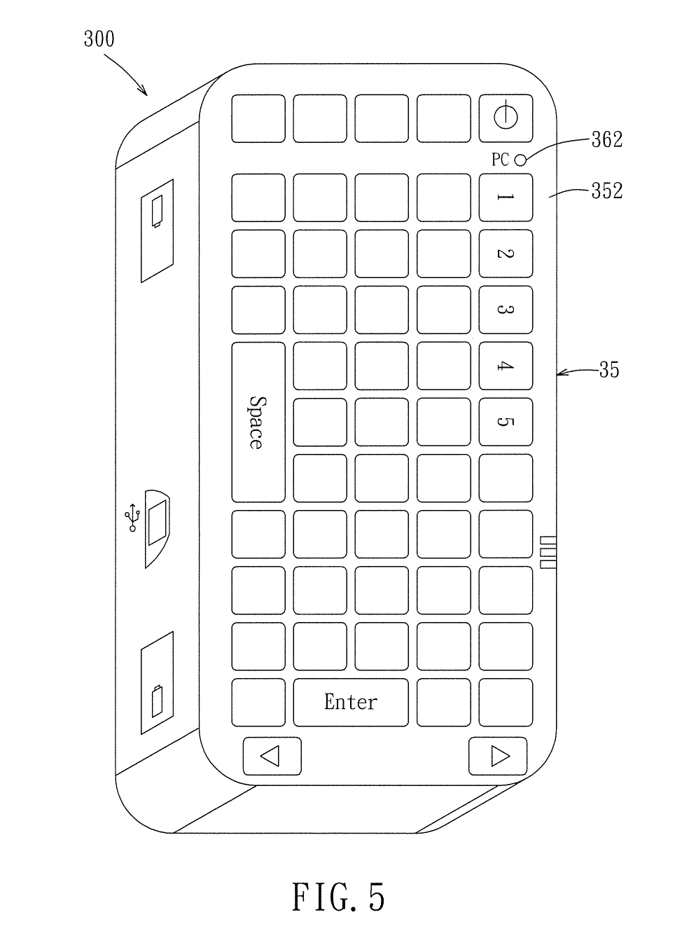

Referring to FIGS. 3 to 5, in the second preferred embodiment of the present invention, the input device 300 is a remote controller which has a first operation surface 351 and a second operation surface 352. The first and second operation surfaces 351, 352 are touchpads, but should not be limited to the disclosure of this embodiment. The first operation surface 351 includes a plurality of virtual buttons for controlling functions of the television 41 such as those shown in FIG. 4. The second operation surface 352 includes a plurality of virtual keys for controlling functions of the computer 42 as shown in FIG. 5. When the user operates the virtual buttons of the first operation surface 351, the first user operable input unit 311 is triggered to output the first input signal 3011. When the user operates the virtual keys of the second operation surface 352, the second user operable input unit 312 is triggered to output the second input signal 3012.

In an aspect of controlling, the input device 300 is preset to operate in the first control mode (i.e., a control mode for controlling the television 41) when the input device 300 is turned on. In the meantime, the first indicator unit 361 corresponding to the first control mode is activated by the control unit 30. When the virtual buttons of the first operation surface 351 are operated by the user, the first input signal 3011 is outputted by the first user operable input unit 311. The control unit 30 is configured to generate the first output signal 302 that is in accordance with the first control mode and that corresponds to the first input signal 3011 from the first user operable input unit 311 corresponding to the first control mode. The transmission unit 33 receives the first output signal 302 from the control unit 30, then processes the first output signal 302 into the formatted wired or wireless first transmission signal 401, and transmits the first transmission signal 401 to the television 41 that corresponds to the first control mode for control. If the user wants to switch control mode of the input device 300, the user may shake the main body 35 of the input device 300. Accordingly, the control unit 30 is configured to switch operation of the input device 300 from the first control mode (i.e., a mode for controlling the television 41) to the second control mode (i.e., a mode for controlling the computer 42) upon determining from the sensor signal 305 that the variation in the acceleration detected by the sensor unit 32 has reached the predetermined threshold. When the input device 300 operates in the second control mode, the second indicator unit 362 corresponding to the second control mode is activated by the control unit 30. In the second control mode, the user operates the virtual keys of the second operation surface 352 for controlling the computer 42, and the second input signal 3012 is outputted by the second user operable input unit 312. The control unit 30 is further configured to generate the second output signal 303 that is in accordance with the second control mode and that corresponds to the second input signal 3012 from the second user operable input unit 312 corresponding to the second control mode. Subsequently, the transmission unit 33 receives the second output signal 303 from the control unit 30, then processes the second output signal 303 into the formatted wired or wireless second transmission signal 402, and transmits the second transmission signal 402 to the computer 42 for control.

In this way, when the input device 300 operates in the first control mode, the virtual key of the second operation surface 352 is disabled, and the second output signal 303 will not be generated. Similarly, when the input device 300 operates in the second control mode, the virtual button of the first operation surface 351 is disabled, and the first output signal 302 will not be generated such that the user may not miss-trigger an undesired control signal.

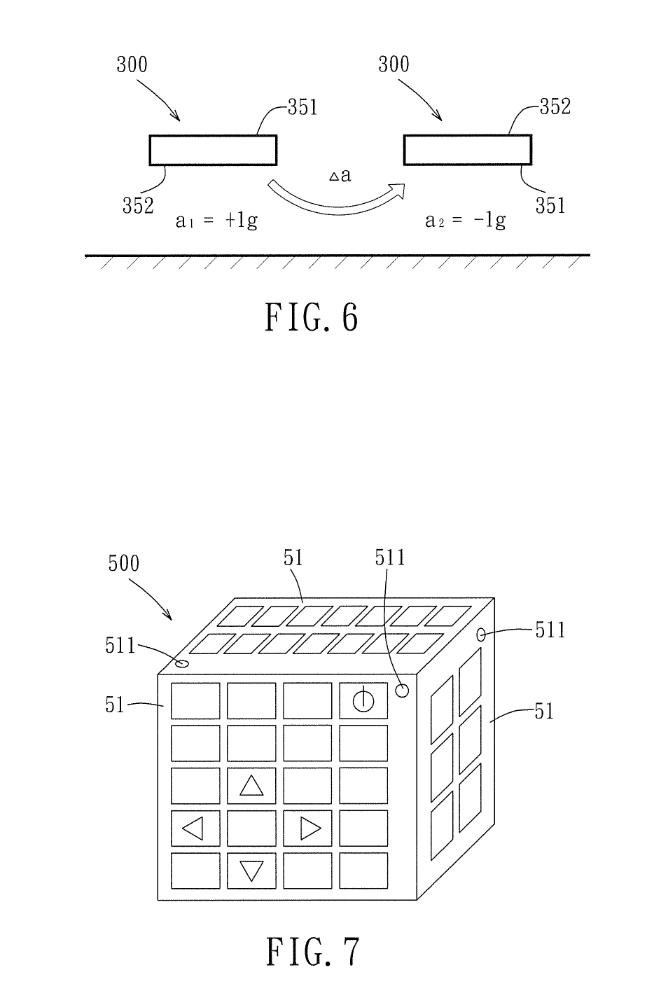

Referring to FIG. 6, a principle for detecting variation in acceleration of the input device 300 is illustrated. Originally, the first operation surface 351 faces upwardly, and the second operation surface 352 faces downwardly. At this moment, the acceleration a1 detected by the sensor unit 32 is +1 g. When the input device 300 is flipped over, the second operation surface 352 faces upwardly, and the first operation surface 351 faces downwardly. At this time, the acceleration a2 detected by the sensor unit 32 is −1 g, such that variation in acceleration Δa may be detected as variation from +1 g to −1 g.

Different embodiments of the main body of the input device of the present invention which is a polyhedron having a plurality of operation surfaces are illustrated hereinafter:

Referring to FIG. 7, a main body of an input device 500 may have a cubic appearance and has six operation surfaces. The input device 500 includes six user operable input units 51 (only three of the user operable input units 51 are shown in FIG. 7), and each of the user operable input units 51 corresponds to a respective one of control modes and is disposed on a respective one of the six operation surfaces. The input device 500 further includes a plurality of indicator units 511 each corresponding to a respective one of the user operable input units 51. In use, only one user operable input unit 51 in which a corresponding one of the indicator units 511 is activated may be operated.

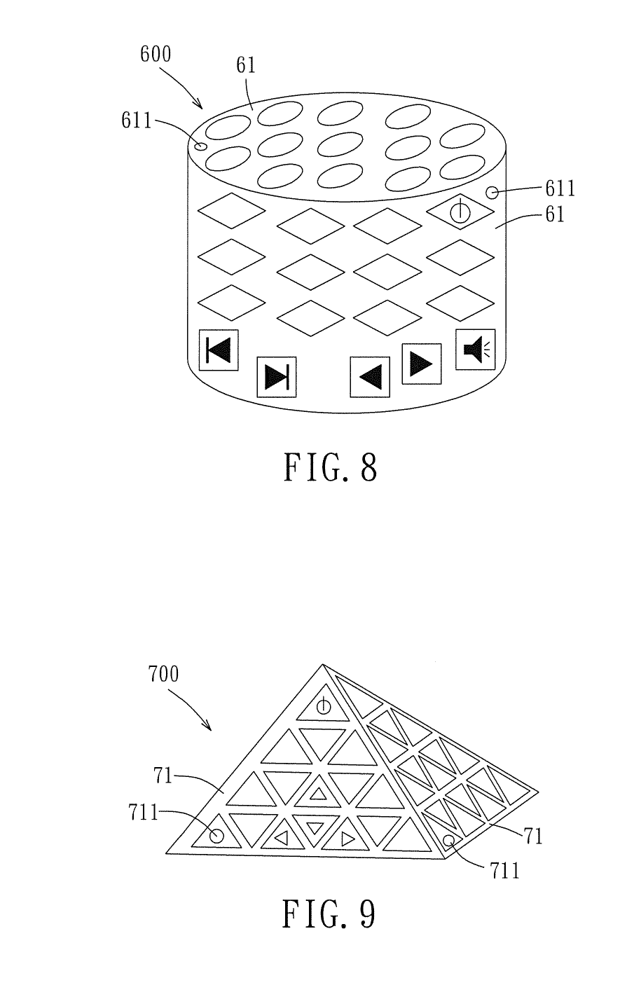

Referring to FIG. 8, a main body of an input device 600 may have a cylindrical appearance and has three operation surfaces. The input device 600 includes three user operable input units 61 (only two of the user operable input units 61 are shown in FIG. 8), and each of the user operable input units 61 corresponds to a respective one of control modes and is disposed on a respective one of the three operation surfaces. The input device 600 further includes a plurality of indicator units 611 each corresponding to a respective one of the user operable input units 61. In use, only one user operable input units 61 in which a corresponding one of the indicator unit 611 is activated may be operated.

Referring to FIG. 9, a main body of an input device 700 may have a pyramidal appearance and has five operation surfaces. The input device 700 includes five user operable input units 71 (only two user operable input units 71 are shown in FIG. 9), and each of the user operable input units 71 corresponds to a respective one of control modes and is disposed on a respective one of the five operation surfaces. The input device 700 further includes a plurality of indicator units 711 each corresponding to a respective one of the user operable input units 71. In use, only one user operable input unit 71 in which a corresponding one of the indicator units 711 is activated may be operated.

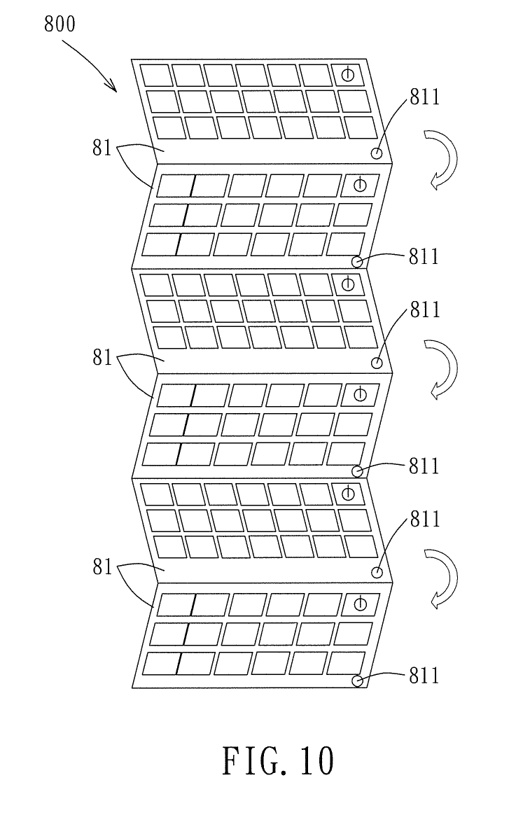

Referring to FIG. 10, a main body of an input device 800 may be a foldable plate unit which has a plurality of plate bodies. The input device 800 includes a plurality of user operable input units 81, and each of the user operable input units 81 corresponds to a respective one of control modes and is disposed on a respective one of the plate bodies. The input device 800 further includes a plurality of indicator units 811 each corresponding to a respective one of the user operable input units 81.

The input device 800 additionally includes a plurality of sensor units (not shown), and each of the plate bodies is provided with one of the sensor units, respectively. The input device 800 further includes a control unit (not shown) which is configured in two ways for switching operation of the input device 800 from one of the control modes to another one of the control modes. In the first way, the control unit is configured to switch operation of the input device 800 from one of the control modes to a specific one of the control modes upon determining from a specific one of the sensor units corresponding to the specific one of the control modes that the variation in the acceleration detected by the specific one of the sensor units has reached a predetermined threshold. For example, when the plate bodies under a top plate body are folded, variation in acceleration detected by each of the sensor units corresponding to a respective one of the folded plate bodies is substantially 0 (i.e., the plate bodies under the top plate body are kept still). Moreover, when the top plate body is flipped over, the sensor unit corresponding to the top plate body detects variation in acceleration of the top plate body, such that the control unit is configured to switch operation of the input device 800 from one of the control modes to the control mode which corresponds to the user operable input unit disposed on the top plate body upon determining that the variation in the acceleration has reached the predetermined threshold. In the second way, whenever any one of the sensor units detects variation in acceleration of a corresponding plate body, the control unit is configured to switch operation of the input device 800 from one of the control modes to another one of the control modes in a preset order upon determining that the variation in the acceleration has reached the predetermined threshold (each of the indicator units 811 is activated by the control unit in the preset order). The user may continue to flip the plate bodies over until a desired control mode is obtained.

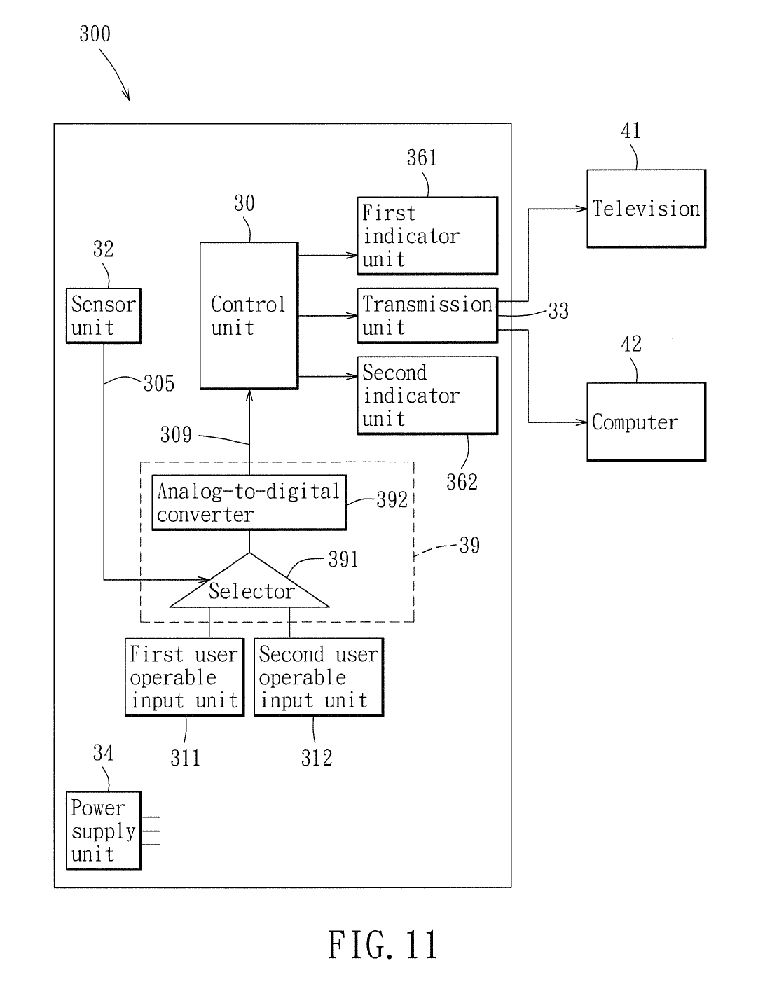

Referring to FIG. 11, a third preferred embodiment of an input device 300 of the present invention is illustrated. The third preferred embodiment is similar to the second preferred embodiment. The input device 300 is operable in a plurality of control modes for providing signals to at least one controlled device (i.e., a television 41 and a computer 42). The input device 300 includes a sensor unit 32, a plurality of user operable input units (a first user operable input unit 311 and a second user operable input unit 312), a control unit 30, a transmission unit 33, a first indicator unit 361, a second indicator unit 362, and a power supply unit 34. The sensor unit 32 is for detecting variation in acceleration of the input device 300 resulting from moving the input device 300, and outputting a sensor signal 305 corresponding to the variation in acceleration detected thereby. Each of the first and second user operable input units 311, 312 corresponds to one of the control modes and is operable by a user to output an input signal.

This embodiment differs from the previous embodiment in that the input device 300 further includes an input selecting unit 39. The input selecting unit 39 is coupled to the sensor unit 32 and the user operable input units 311, 312. The input selecting unit 39 is configured to switch operation of the input device 300 from one of the control modes to another one of the control modes upon determining from the sensor signal 305 that the variation in the acceleration detected by the sensor unit 32 has reached a predetermined threshold, and to select the input signal from the user operable input unit corresponding to a current one of the control modes, in which the input device 300 operates, for generating an intermediate signal 309 to be outputted thereby. The input selecting unit 39 includes a selector 391 and an analog-to-digital converter 392. The selector 391 is for selecting the input signal from the user operable input unit corresponding to the current one of the control modes. The analog-to-digital converter 392 is coupled to the selector 391 for receiving the selected input signal, performing analog-to-digital conversion on the selected input signal so as to obtain the intermediate signal 309, and outputting the intermediate signal 309 to the control unit 30. In an alternative implementation, the input selecting unit 39 may include a multiplexer for establishing a signal path between the control unit 30 and the user operable input unit corresponding to the current one of the control modes so as to achieve the same effect of the selector 391. The analog-to-digital converter 392 may be omitted in some embodiments.

The control unit 30 is coupled to the input selecting unit 39 and is configured to generate an output signal that is in accordance with the current one of the control modes and that corresponds to the intermediate signal 309 from the input selecting unit 39. The transmission unit 33 is coupled to the control unit 30, receives the output signal from the control unit 30, and transmits the output signal to the controlled device (i.e., the television 41 or the computer 42).

Preferably, the input selecting unit 39 and the control unit 30 are integrated into one integrated circuit component.

Preferably, the input selecting unit 39 and the control unit 30 are implemented as separate integrated circuit components.

Preferably, each of the user operable input units 311, 312 includes at least one of a touch input unit, a key input unit, and a voice input unit.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An input device operable in a plurality of control modes for providing signals to at least one controlled device, said input device comprising:
a sensor unit for detecting variation in acceleration of said input device resulting from moving said input device, and outputting a sensor signal corresponding to the variation in acceleration detected thereby;
a user operable input unit operable by a user to output an input signal;
a control unit coupled to said sensor unit and said user operable input unit, said control unit being configured to switch operation of said input device from one of the control modes to another one of the control modes upon determining from the sensor signal that the variation in the acceleration detected by said sensor unit has reached a predetermined threshold, said control unit being further configured to generate an output signal that corresponds to the input signal and that is in accordance with a current one of the control modes in which said input device operates; and
a transmission unit coupled to said control unit, receiving the output signal from said control unit, and transmitting the output signal to the controlled device.

2. The input device as claimed in claim 1, further comprising a plurality of indicator units coupled to said control unit, each of said indicator units corresponding to one of the control modes and being activated by said control unit when said input device operates in the corresponding one of the control modes.

3. The input device as claimed in claim 1, wherein said user operable input unit includes at least one of a touchpad and a physical keyboard.

4. The input device as claimed in claim 1, wherein said transmission unit is a wireless transmission unit.

5. The input device as claimed in claim 4, wherein said wireless transmission unit is selected from a Bluetooth transmitter, a wireless broadband transmitter, a Zigbee transmitter, and a radio-frequency transmitter.

6. The input device as claimed in claim 1, wherein said transmission unit is a wired transmission unit.

7. The input device as claimed in claim 6, wherein said wired transmission unit is selected from a USB port, an IEEE1394 transmission port, and a UART transmission port.

8. An input device operable in a plurality of control modes for providing signals to at least one controlled device, said input device comprising:
a sensor unit for detecting variation in acceleration of said input device resulting from moving said input device, and outputting a sensor signal corresponding to the variation in acceleration detected thereby;
a plurality of user operable input units each corresponding to one of the control modes and being operable by a user to output an input signal;
a control unit coupled to said sensor unit and said user operable input units, said control unit being configured to switch operation of said input device from one of the control modes to another one of the control modes upon determining from the sensor signal that the variation in the acceleration detected by said sensor unit has reached a predetermined threshold, said control unit being further configured to generate an output signal that is in accordance with a current one of the control modes in which said input device operates and that corresponds to the input signal from said user operable input unit corresponding to the current one of the control modes; and
a transmission unit coupled to said control unit, receiving the output signal from said control unit, and transmitting the output signal to the controlled device.

9. The input device as claimed in claim 8, further comprising a plurality of indicator units coupled to said control unit, each of said indicator units corresponding to one of the control modes and being activated by said control unit when said input device operates in the corresponding one of the control modes.

10. The input device as claimed in claim 8, wherein each of said user operable input units includes at least one of a touchpad and a physical keyboard.

11. The input device as claimed in claim 8, wherein said transmission unit is a wireless transmission unit.

12. The input device as claimed in claim 11, wherein said wireless transmission unit is selected from a Bluetooth transmitter, a wireless broadband transmitter, a Zigbee transmitter, and a radio-frequency transmitter.

13. The input device as claimed in claim 8, wherein said transmission unit is a wired transmission unit.

14. The input device as claimed in claim 13, wherein said wired transmission unit is selected from a USB port, an IEEE1394 transmission port, and a UART transmission port.

15. An input device operable in a plurality of control modes for providing signals to at least one controlled device, said input device comprising:
a sensor unit for detecting variation in acceleration of said input device resulting from moving said input device, and outputting a sensor signal corresponding to the variation in acceleration detected thereby;
a plurality of user operable input units each corresponding to one of the control modes and being operable by a user to output an input signal;
an input selecting unit coupled to said sensor unit and said user operable input units, said input selecting unit being configured to switch operation of said input device from one of the control modes to another one of the control modes upon determining from the sensor signal that the variation in the acceleration detected by said sensor unit has reached a predetermined threshold, and to select the input signal from said user operable input unit corresponding to a current one of the control modes, in which said input device operates, for generating an intermediate signal to be outputted thereby;
a control unit coupled to said input selecting unit and configured to generate an output signal that is in accordance with the current one of the control modes and that corresponds to the intermediate signal from said input selecting unit; and
a transmission unit coupled to said control unit, receiving the output signal from said control unit, and transmitting the output signal to the controlled device.

16. The input device as claimed in claim 15, wherein said input selecting unit includes
a selector for selecting the input signal from said user operable input unit corresponding to the current one of the control modes; and
an analog-to-digital converter coupled to said selector for receiving the selected input signal, performing analog-to-digital conversion on the selected input signal so as to obtain the intermediate signal, and outputting the intermediate signal to said control unit.

17. The input device as claimed in claim 15, wherein said input selecting unit includes a multiplexer for establishing a signal path between said control unit and said user operable input unit corresponding to the current one of the control modes.

18. The input device as claimed in claim 15, wherein said input selecting unit and said control unit are integrated into one integrated circuit component.

19. The input device as claimed in claim 15, wherein said input selecting unit and said control unit are implemented as separate integrated circuit components.

20. The input device as claimed in claim 15, wherein each of said user operable input units includes at least one of a touch input unit, a key input unit, and a voice input unit.

21. An input method to be performed by an input device for providing signals to at least one controlled device, the input device being operable in a plurality of control modes, the control method including:
a) detecting, through a sensor unit of the input device, variation in acceleration of the input device resulting from moving the input device, and outputting a sensor signal corresponding to the detected variation in acceleration;
b) configuring a control unit of the input device to switch operation of the input device to a selected one of the control modes with reference to the sensor signal; and
c) selecting one of a plurality of input signals according to the selected one of the control modes and transmitting the selected one of the input signals to the controlled device.
